(19) United States
(12) Patent Application Publication
(10) Pub. No.: US 2010/0145912 A1
(43) Pub. Date: Jun. 10, 2010

(54) DETECTING PEER TO PEER APPLICATIONS

(75) Inventors: Jian Li, San Ramon, CA (US); Kaiyan Chen, Pleasanton, CA (US); Raghvendra Savoor, Walnut Creek, CA (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/329,955

(22) Filed: Dec. 8, 2008

(51) Int. Cl. G06F 17/30; G06F 7/06; G06F 15/16; G06F 15/173; G06F 7/00

(52) U.S. Cl. 707/622; 709/224; 707/E17.045

(57) ABSTRACT

Peer-to-peer (P2P) applications are detected by analyzing entries in a residential gateway network address translation table. A quantity of available communication sessions provides a first indication of whether a P2P application is running. A quantity of unique addresses is compared to a quantity of unique destination ports and the result provides a further indication of whether a P2P application is running.

### BACKGROUND

1. Field of the Disclosure

The present disclosure generally relates to data networks and more particularly to detecting peer-to-peer (P2P) applications.

2. Description of the Related Art

Network administrators may wish to detect and monitor P2P applications that consume a large portion of network bandwidth. In some systems, P2P applications are detected and monitored using deep packet inspection.

### BRIEF DESCRIPTION OF THE DRAWINGS

FIG. 1 illustrates representative components for detecting P2P applications in accordance with disclosed embodiments;

FIG. 2 illustrates selected components in a network address translation (NAT) table that is analyzed to detect P2P applications in accordance with disclosed embodiments;

FIG. 3 illustrates representative elements of a disclosed method for detecting P2P applications;

FIG. 4 further illustrates representative elements of a disclosed method for detecting P2P applications; and

FIG. 5 further illustrates representative elements of a disclosed method for detecting P2P applications.

### DESCRIPTION OF EXEMPLARY EMBODIMENTS

P2P applications have become popular and may use a large percentage of bandwidth consumption over an Internet service provider's (ISP's) edge and core networks. Disclosed embodiments assist with identifying those users of an ISP who run P2P applications, with identifying the P2P traffic over the users' network links, and with analyzing usage patterns to detect P2P connections. Disclosed embodiments provide data that can help customer support personnel diagnose user connection issues or provide the identities of P2P operators that may be instructed to limit P2P usage to avoid affecting the quality of video, audio, or voice over Internet protocol (VoIP) transmissions.

In one aspect, a disclosed process detects P2P connections from a local network address by accessing and analyzing an NAT table to determine a quantity of communication sessions available. The quantity of available communications is stored and compared to a maximum level of communication sessions. If the quantity of available communication sessions meets or exceeds the maximum level, a P2P connection variable is stored as TRUE, and in some embodiments, if the quantity does not meet or exceed the maximum level, the P2P connection variable is set as FALSE. The maximum level of communication sessions may be a total number (e.g., 1024) of available communication sessions for a residential gateway (RG) or client, or may be determined as a fraction (e.g., 900/1024) of the total number of available communication sessions for the RG or client.

In some embodiments, after accessing the NAT table, the number of unique destination network addresses coupled to a local port is determined. The quantity of unique destination network addresses is stored and compared to a maximum level of unique destination addresses. A P2P connection variable is set as TRUE if the quantity of unique destination addresses meets or exceeds the maximum level of unique destination addresses. The disclosed process may further include storing the P2P connection variable as FALSE if the quantity of unique destination addresses is less than the maximum level of unique destination addresses.

If a local service port is otherwise analyzed according to disclosed methods, it may render a false positive regarding a P2P connection for a client. Therefore, in some embodiments, an identifier of a local port under analysis is compared to a plurality of known non-P2P port identifiers (e.g., Internet protocol television (IPTV) service port identifiers). If a local port that has above the maximum level of unique destination addresses is a well-known non-P2P service port, the disclosed process may store a connection variable for the port as FALSE to indicate no P2P connection or application.

Disclosed processes may include repeating procedures for accessing the NAT table to determine the quantity of unique destination addresses for other local ports. In some embodiments, well-known non-P2P ports or IPTV service ports may be removed from analysis under disclosed processes. However, for other individual local ports, the quantity of unique destination addresses is compared to a quantity of unique destination ports. A P2P connection variable is stored as TRUE if the quantity of unique destination addresses is equal to the quantity of unique destination ports. If the quantity of unique destination addresses is substantially equal to the quantity of unique destination ports, a difference value is determined by subtracting a quantity of unique destination ports from the quantity of unique destination addresses. In the event the number resulting from this subtraction is a negative value, an absolute value of the number is taken so that the difference value is positive. In accordance with the disclosed process, the P2P connection variable is stored as TRUE if the ratio of unique destination addresses to unique destination ports is equal to 1 or, the P2P connection variable is stored as TRUE if the ratio is substantially equal to 1 and the difference value is less than or equal to a maximum difference value (e.g., 10). In some embodiments, the process includes storing the P2P connection variable as FALSE if the ratio is not substantially equal to 1 (or is equal to 1). The disclosed process, including accessing the NAT table, may be performed by components of an RG that stores the NAT table locally (i.e., local to the RG). Accordingly, in some embodiments the process includes transporting NAT table data to a detection server responsive to a server request. Transporting NAT table data to the detection server may be scheduled to occur after a predetermined period or may occur upon a detection event, such as the RG detecting a potential P2P application.

In another aspect, a disclosed detection server is implemented to detect P2P applications by executing instructions that access and analyze an NAT table of a client. The accessed NAT table includes a plurality of entries with stored data for communication sessions between a local customer premises device (CPE) and at least one remote device. Individual entries in the client's NAT table are associated with a destination address, a destination port, a source port, and a source address. The detection server includes instructions for determining whether a threshold number (e.g., 20) of entries have differing destination addresses while having the same source address and source port. If a threshold number of entries have differing destination addresses, the client is flagged as a potential P2P operator.

Embodied detection servers may also execute machine-readable instructions to determine a difference value between a quantity of unique destination addresses and a quantity of unique destination ports in the NAT table. If the difference value is less than or equal to a threshold number (e.g., 10), the client may be flagged as a potential P2P operator. In some embodiments, if the difference value is greater than the threshold number, the client is unflagged (i.e., removed from then current consideration) as a potential P2P operator.

In still another aspect, a disclosed RG is implemented for detecting a P2P application. The RG includes an interface that enables communication over a network between the local client and potentially multiple remote sources. A disclosed RG includes an NAT table stored on a tangible readable medium that includes session entries with data indicating communication sessions between the local client and multiple remote resources. Each of the multiple remote resources is associated with a remote network address and a remote port. The disclosed RG includes or communicates with a processor enabled for executing machine-readable instructions to determine a relationship (e.g., a ratio) between the remote network addresses associated with the multiple remote sources and the remote ports associated with the multiple remote sources. In some embodiments, the relationship is a ratio. The processor may report a P2P application in response to the ratio being equal to 1. The RG may report a P2P application to a detection server or other network-based (i.e., remote) device. If the ratio is substantially equal to 1, but is not equal to 1, a difference value may be calculated between a quantity of unique remote network addresses and a quantity of unique remote ports. If the difference value is less than or equal to a maximum value (e.g., 10), the RG may report a P2P application to the detection server.

In the following description, examples are set forth with sufficient detail to enable one of ordinary skill in the art to practice the disclosed subject matter without undue experimentation. It should be apparent to a person of ordinary skill that the disclosed examples are not exhaustive of all possible embodiments. Regarding reference numerals used to describe elements in the figures, a hyphenated form of a reference numeral typically refers to a specific instance of an element and an un-hyphenated form of the reference numeral typically refers to the element generically or collectively. Thus, for example, element 112-1 refers to an instance of a remote source, which may be referred to collectively as remote sources 112 and any one of which may be referred to generically as a remote source 112.

Disclosed embodiments are intended to provide lightweight methods and systems for RG based identification of P2P applications and P2P users. By analyzing the relationships between local and remote pairings as evidenced within an RG's NAT table (i.e., NAT session tables), disclosed processes attempt to recognize P2P connections. For example, relationships between and among local IP addresses, corresponding local ports, remote IP addresses and corresponding remote ports within the NAT table are analyzed to detect whether P2P applications are likely running or have likely run. By utilizing readily available information (e.g., NAT table data) from RGs, disclosed embodiments may provide a lighter weight solution than deep packet inspection techniques. However, disclosed embodiments may operate in conjunction with deep-packet-inspection (DPI) techniques, methods, processes, and systems.

To monitor and analyze customer traffic patterns including P2P applications, DPI techniques may capture and analyze traffic at the full bit rate of transmission. A packet flow may be identified by a five-element tuple, for example: (src_ip, src_port, dst_ip, dst_port, protocol_number). Using pattern recognition methods, DPI systems attempt to match captured traffic patterns with predefined signatures to identify the application type of a particular packet flow. Example application types include without limitation: P2P, Web/Hypertext Transfer Protocol (Web/HTTP), File Transfer Protocol (FTP), and Domain Name System (DNS).

DPI techniques may be challenging. DPI techniques require looking into packet payloads, which may raise privacy issues. In addition, DPI techniques and systems may be challenged to detect P2P flows that are encrypted so as to obfuscate their protocols. In such cases, a DPI technique may not be able to identify some P2P applications. In addition, DPI techniques require expensive hardware and software systems that make deployment over a wide geographic area difficult. What is more, if a DPI technique or system includes inserting monitoring equipment at a hub office or other centralized location, it may be difficult to capture and/or analyze P2P traffic flowing from one customer to another customer service via the same hub office.

Disclosed systems offer advantages over only using DPI techniques. Disclosed systems analyze NAT tables (i.e., NAT session tables), which are typically readily-available from an RG, to determine if a user is running a P2P application (i.e., to determine if the user is a P2P user or operator). The NAT table information (i.e., data) may be remotely pulled by a detection server from a user RG using a customized script. The NAT table data may then be parsed to derive relevant information for identifying P2P users.

Disclosed embodiments may operate using a combination of techniques for analyzing the NAT data. Firstly, the NAT data may be analyzed to determine the number of available sessions available and thereby estimate whether a user is likely running a P2P application. An NAT table in an RG may be limited, for example, to storing 1024 session entries. If a user is running a P2P application, the number of available sessions typically drops to a very low number (e.g., zero) at times. However, the number of available sessions is dynamic, so it may be difficult to detect when the number of sessions is low or zero. Another challenge in detecting P2P connections with this technique is that if a P2P file sharing task is not very popular (i.e., online swarm is small), it may not cause the NAT table to be exhausted of available sessions. In such cases, further disclosed techniques for analyzing the NAT table data may be employed.

Another technique that may be used by disclosed embodiments includes, for example, comparing a number of destination addresses to a minimum number of addresses, determining a ratio of a quantity of unique destination addresses to a quantity of unique destination ports, and determining a difference between the quantity of unique destination addresses and the quantity of unique destination ports. If there are less than, for example, twenty unique destination addresses connected to a local address on the same local port, it suggests that a P2P application is not running. Also, if the local port is a well known non-P2P service port such as 80 or 8080, or if the local port is an IPTV service port, disclosed systems may determine that a P2P application is not running.

However, if there are more than 20 unique destination addresses connected to a local address on the same local port, it is an indication of a P2P application. If the ratio of the quantity of unique destination addresses to the quantity of unique destination ports is 1, it is an indication that a user is running a P2P application and the user (or user client) may be flagged as a potential P2P operator. If the ratio is substantially equal to 1 and if the difference between the quantity of unique destination addresses and the quantity of unique destination ports is less than or equal to a minimum level (e.g., 10), disclosed systems may report a P2P application and a P2P variable may be set and stored as TRUE. In addition, a user client may be notified by a detection server, for example, to stop the P2P application.

In some embodiments, in response to determining that a P2P application is not running, a P2P variable is set and stored as FALSE. For example, if the ratio is substantially equal to 1 and the difference (the absolute value) between a quantity of unique destination addresses and the quantity of unique destination ports is greater than 10, disclosed systems may flag a user or client as a non-P2P operator.

In some embodiments, an RG monitors connection patterns by analyzing its own NAT table and tracking any potential P2P usage. The RG may periodically (e.g., daily) send to a detection server or other network device the NAT table data or may send a report summarizing any detected P2P usage. In some embodiments, the RG may respond to a detection server request to provide relevant NAT table data. Generally, disclosed systems that determine the ratio of the quantity of unique destination addresses to the quantity of unique destination ports and the difference between the quantity of unique destination addresses and the quantity of unique destination ports are intended to not depend on the timing of any NAT table pull (or push) and are intended to not depend on peer swarm size. In addition, because different P2P applications may be running on different local port numbers or different RG port numbers, such methods are intended to detect if a user is running more than one type of P2P application.

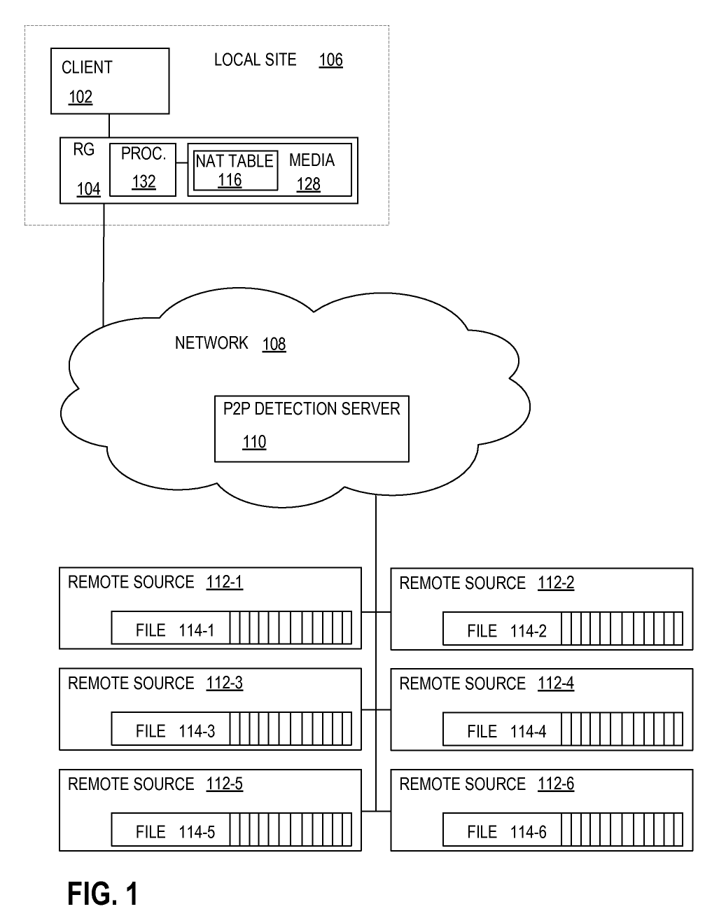

Referring now to the figures, FIG. 1 depicts a block diagram of an environment for detecting P2P applications in accordance with disclosed embodiments. As shown, local site 106 (e.g., a residence or business) includes RG 104 that facilitates communication between client 102 and network 108. Network 108 may be an ISP or similar network communicatively coupled to an Internet. As shown, client 102 may communicate through RG 104 with one or more remote sources 112 over network 108. During a P2P connection, client 102 may receive parts of file 114 from more than one of remote sources 112. FIG. 1 shows a copy of file 114 stored on each remote source 112. Remote sources 112 may communicate with client 102 through network 108 through separate networks (not depicted) that are in different geographic areas, for example. Accordingly, remote source 112-1 may be serviced by different network components (e.g., a different Dynamic Host Configuration Protocol server) than remote sources 112-2, 112-3, 112-4, 112-5 and 112-6.

During a P2P connection, (i.e., while running a P2P application as a P2P operator or user), client 102 may receive portions of file 114 from various combinations of the remote sources 112. For example, client 102 may receive from remote source 112-1 the first sixth of file 114, may receive from remote source 112-2 the second sixth of file 114, may receive from remote source 112-3 the third sixth of file 114, and so on. In this way, client 102, as a P2P operator, may receive different portions of file 114 from a plurality of remote sources 112.

As shown, RG 104 includes a processor 132 and media 128, which is a tangible computer readable medium that may include drive media, solid-state media, volatile media, persistent media, magnetic media and other forms of storage. As shown, media 128 includes NAT table 116 and may also include computer executable instructions that enable RG 104 to detect when client 102 is running a P2P application. RG 104 includes an interface for communicating with network 108 and an interface for communicating with client 102. NAT table 116 includes session entries with data indicating communication sessions between client 102 and one or more remote sources 112. Each remote source 112 in communication with client 102 is associated with a remote network address (i.e., a destination address) and a remote port (i.e., destination port) and data indicative of these addresses and ports is stored in NAT table 116.

As shown, processor 132 executes instructions for determining a relationship (e.g., a ratio) between the remote network addresses associated with remote sources 112 and the remote ports (not depicted) associated with remote sources 112. For example, processor 132 may determine that a ratio between remote network addresses in NAT table 116 (that are associated with remote resources 112) and unique destination ports (that are associated with remote resources 112) is equal to 1. If more than a minimum number (e.g., 20) of NAT sessions are logged in NAT table 116 and the ratio is equal to 1, the processor may flag client 102 as a P2P operator. Accordingly, RG 104 may report to P2P detection server 110 or other network components that client 102 is a P2P operator.

If the ratio is not equal to one but is substantially equal to 1 (e.g., within 6% of 1), then a difference value that is the absolute value of the difference between the quantity of unique remote network addresses and the quantity of unique remote ports is calculated. If the difference value is less than or equal to a maximum level (e.g., 10), a P2P application is reported and a P2P variable may be set as TRUE. However, if the difference value is greater than the maximum level, a P2P variable may be set as FALSE.

As shown in FIG. 1, P2P detection server 110 is enabled to perform a disclosed process to detect P2P connections between client 102 and one or more remote sources 112. The process includes P2P detection server 110 accessing data from NAT table 116 to determine a quantity of available communication sessions. The quantity of available sessions is stored and compared to a minimum level of sessions. For example, RG 104 may have capacity for a total of 1024 session entries in NAT table 116. A minimum level of available sessions may be set at 300, for example, which means 724 entries may be used before a P2P application is reported. Accordingly, if fewer than 300 entries are available in NAT table 116 (i.e., if more than 724 session entries are stored in NAT table 116), then a P2P application is reported. In accordance with the disclosed process, a peer-to-peer connection variable may be set and stored as TRUE if the level of available sessions is equal to or less than the minimum level of available sessions.

If the disclosed process is performed by P2P detection server 110, a detected level of available communication sessions that is less than the minimum level of available sessions results in P2P detection server 110 storing a P2P connection variable as TRUE. In some embodiments, if the quantity of available sessions is greater than the minimum level of sessions, P2P detection server 110 stores the P2P connection variable as FALSE. To help prevent a false detection of a P2P connection, P2P detection server 110 may determine whether used communication sessions listed in NAT table 116 correspond to well-known non-P2P service ports (e.g., 80 or 8080). If a used communication session corresponds to a well-known non-P2P service port, P2P detection server 110 may take this into account when determining whether a P2P connection may exist. For example, one communication session may be subtracted from the number of used communication sessions for each communication session in the NAT table that uses a well-known non-P2P service port.

In some disclosed processes, P2P detection server 110 determines from NAT table 116 a quantity of unique destination network addresses communicatively coupled to a local port. The quantity of unique destination network addresses is stored and compared to a maximum level (e.g., 20) of unique destination addresses. If the quantity of unique destination addresses meets or exceeds the maximum level of unique destination addresses, a client may be flagged as a potential P2P operator and, in some cases, a P2P connection variable may be stored as TRUE. In contrast, if the quantity of unique destination addresses is less than the maximum level (e.g., 20) of unique destination addresses, P2P detection server 110 may unflag the client as a potential P2P operator and store or rewrite the P2P connection variable as FALSE. If a quantity of unique destination addresses meets or exceeds the maximum level of unique destination addresses and an identifier of a local port corresponding to the unique destination addresses is identical to an identifier of a known non-P2P service port, then P2P detection server 110 may store the P2P connection variable as FALSE. Alternatively, if a local port is identified as a well-known non-P2P service port (e.g., 80, 8080, or an IPTV service port), any unique destination addresses communicating with the local service port may be removed from the quantity of unique destination addresses used to help detect a P2P connection.

Disclosed processes may repeat for each unique local port operation for accessing NAT table 116 data and determining a quantity of unique destination network addresses. For individual ports, a quantity of unique destination addresses is compared to a quantity of unique destination ports. A client may be flagged as a potential P2P operator if the quantity of unique destination addresses is equal to the quantity of unique destination ports and the quantity of unique destination addresses exceeds a threshold level (e.g. 20). The client may be flagged by storing a P2P connection variable as TRUE.

In some disclosed processes, P2P detection server 110 performs at least two operations to detect P2P connections. First, for individual ports of the local ports, P2P detection server 110 determines a ratio of the quantity of unique destination addresses to a quantity of unique destination ports. Second, if the ratio is substantially equal to one, P2P detection server 110 determines a difference value by subtracting the quantity of unique destination ports from the quantity of unique destination addresses. A client is flagged as a potential P2P operator if the ratio is substantially equal to 1 and the difference value is less than or equal to a maximum difference value (e.g., 10). In some embodiments, if the client is flagged as a potential P2P operator, a P2P connection variable is stored as TRUE. The P2P connection variable may be stored as FALSE if the ratio is not substantially equal to 1 (or is not equal to 1) or the difference value is greater than the maximum difference value (e.g., 10).

As shown in FIG. 1, although the disclosed process may be described above as performed by P2P detection server 110, RG 104 may also perform the disclosed process and transport NAT data to P2P detection server 110 responsive to a server request by P2P detection server 110. In this way, RG 104 may provide P2P connection statistics on-demand. Historical statistics on P2P usage may be stored on media 128 for a predetermined duration or on a rolling basis. In some cases, P2P usage data is stored on media 128 on a first in first out basis. P2P usage data may be stored locally to media 128 in response to RG 104 detecting a potential P2P event.

In still other embodiments, P2P detection server 110, as shown in FIG. 1, executes machine readable instructions stored on at least one tangible readable medium (not depicted) to detect P2P applications. Accordingly, P2P detection server 110 accesses a network address table (e.g., NAT table 116) of a client (e.g., client 102) that includes a plurality of entries indicating communication sessions between a local CPE device (e.g., client 102) and at least one remote device (e.g., remote source 112). In such embodiments, entries in NAT table 116 may be associated with a destination address, a destination port, a source port, and a source address. P2P detection server 110 determines whether in NAT table 116 a threshold number (e.g., 20) of session entries have differing destination addresses while having the same source address and same source port. If P2P detection server 110 determines that the threshold number (e.g., 20) of entries have differing destination addresses while having the same source address and same source port, the client (e.g., client 102) is flagged as a potential peer-to-peer operator.

As an additional step to determine whether the client is a P2P operator, RG 104 may determine a ratio of unique destination addresses to unique destination ports. If the ratio is equal to 1, the client is flagged as a potential P2P operator. If the ratio is not equal to 1 but is within a tolerance value (e.g., 6%) of 1, P2P detection server 110 may additionally determine whether a difference value, which is the absolute value of the quantity of unique destination ports subtracted from a quantity of unique destination addresses, is less than or equal to a threshold number (e.g., 10). If the difference value is greater than the threshold number (e.g., 10), the client may be unflagged as a potential P2P operator.

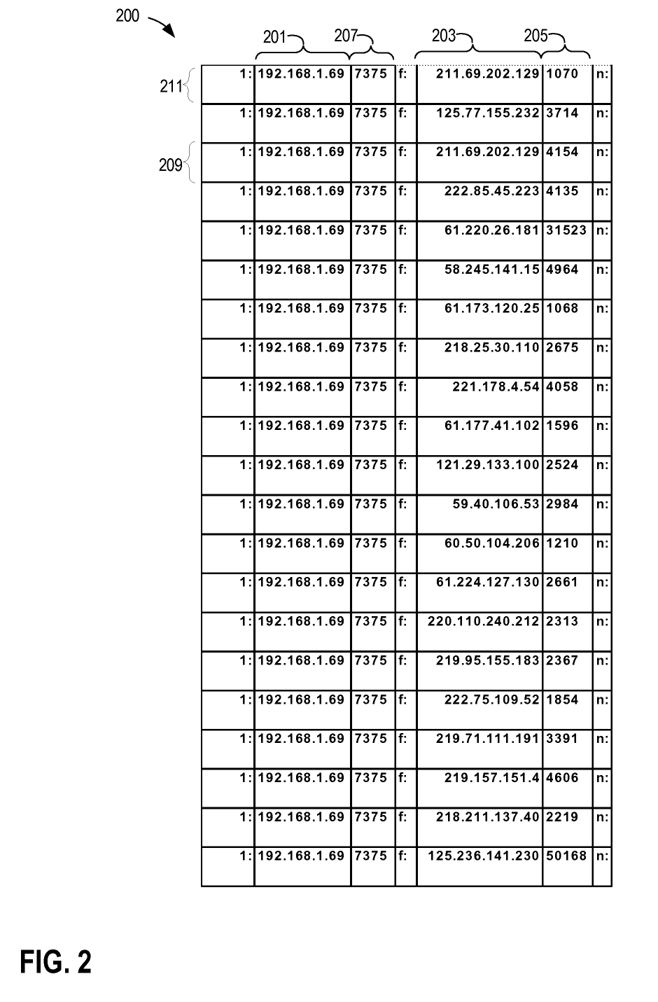

In FIG. 2, an exemplary NAT table 200 is illustrated. As shown, NAT table 200 includes column 201 which includes source addresses (i.e., local addresses), column 207 which includes source ports (i.e., local ports), column 203 which includes destination addresses (i.e., remote addresses), and column 205 which includes destination ports (i.e., remote ports). As shown, entry 211 and entry 209 have the same source address (i.e., “192.168.1.69”), the same source port (i.e., “7375”), the same destination address (i.e., “211.69.202.129”) and differing destination ports. Specifically, entry 211 has a destination port in column 205 of “1070” and entry 209 has a destination port in column 205 of “4154.” Each of the other destination addresses in column 203 is unique as compared to the others. Similarly, as shown in column 205, each of the destination ports is unique.

As shown in NAT table 200 in FIG. 2, numerous unique remote addresses (e.g., Internet IPs) are connected (i.e., communicatively coupled) to a local address (e.g., a local IP) on the same local port (i.e., local port 7375). In accordance with disclosed embodiments, if a threshold number (e.g., 20) of unique destination addresses appears in column 203, then a P2P application may be using a local address 192.168.1.69. As shown in NAT table 200, 21 entries and 20 destination addresses in column 203 are unique, so the first condition is satisfied and a P2P application may be evidenced in NAT table 200. If local port 7375 is not a well-known non-P2P service port (e.g., 80 or 8080), NAT table 200 may still be considered to evidence a P2P application. Some embodiments may refer to a database of known service ports to determine whether the local port as shown in column 207 is an IPTV service port or well-known non-P2P port.

If initial analysis shows that a threshold number of unique destination addresses occur in an NAT table for source ports that are not included in a database of known non-P2P ports, further analysis is conducted to detect a P2P application. Specifically, a ratio of the number of unique destination addresses to the number of unique destination ports is determined according to the following formula:

$$ip 2 port\_ratio = \frac{the \# of unique dst IPs}{the \# of unique dst ports} .$$

If the ratio is equal to 1 then a client is flagged as a potential P2P operator. This is because typically only peers establish a single TCP connection to a unique peer. If the ratio is substantially equal to 1 and a difference value (calculated as the absolute value of the number of unique destination addresses minus the number of unique destination ports) is less than or equal to a threshold value (e.g., 10), it is also an indication that a P2P application is running. The difference is calculated according to the following equation:

ip2port_diff=|the # of unique dst IPs−the # of unique dst ports|

As shown in NAT table 200, there are 20 unique destination addresses in column 203 and 21 unique destination ports. This yields, according to the above formula, a ratio of 0.95, which is within a threshold tolerance of 6% of 1, and is therefore considered substantially equal to 1. The difference is calculated as the absolute value of 20-21, which yields 1. If the threshold value is 10, the calculated difference of 1 is less than 10, and this indicates that the application using source address 192.168.1.69 and source port 7375 is likely a P2P application. The difference calculation allows for a relatively small difference between the number of destination addresses and destination ports, which may be due to a unique P2P contact (e.g., a unique IP) having two sessions on two different ports: one session on a TCP port, the other on a different UDP port, with both sessions connected to the same local port. If the ratio is far away from 1 or is not substantially equal to 1 and the difference is greater than the threshold value (e.g., 10), then the NAT table is not considered to evidence a P2P application.

Detecting P2P applications as discussed above may be conducted by a network based P2P detection server or by a local RG (e.g., RG 104 in FIG. 1) that monitors connection patterns by analyzing NAT tables and keeping track of potential P2P usage. If performed by an RG, statistics may be pushed to a P2P detection server proactively (e.g., according to a predetermined schedule) or may be pulled on demand. Historical statistics on P2P usage may be stored on an embodied RG for a predetermined time and may be deleted or replaced on a rolling basis with the oldest or least relevant data being written over.

Accordingly, disclosed embodiments provide relatively lightweight systems for detection of P2P applications and do not necessarily require looking into packet payload. Such systems may help to detect P2P flow even if the flow is encrypted. P2P user identification can help in diagnosing some user connection issues and may be used to instruct users to limit P2P usage in certain situations to avoid affecting quality of video or VoIP transmissions.

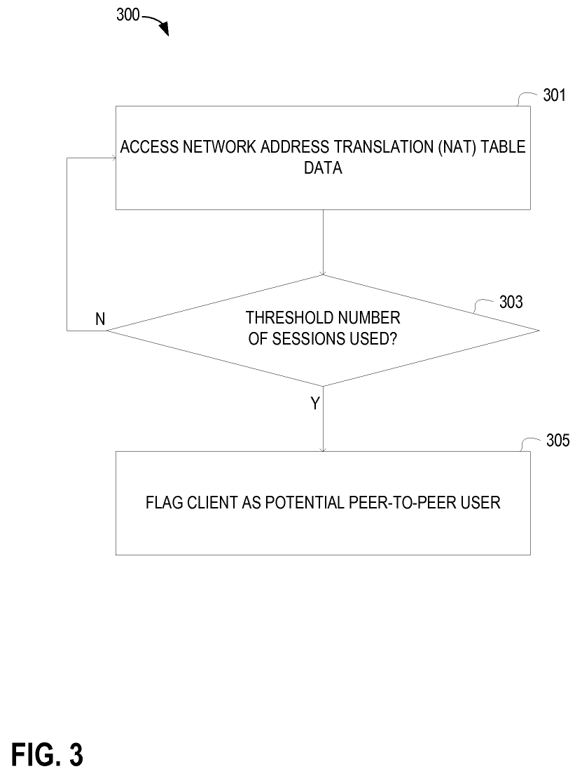

FIG. 3 depicts a disclosed method 300 for potentially flagging a client as a P2P operator. As shown, NAT table data is accessed (block 301) and a determination is made (block 303) whether a threshold number (e.g., 20) of sessions is used. If less than the threshold number of sessions is used, method 300 returns to access (block 301) and analyzes more data. If the threshold number of sessions is used as determined in block 303, then the client is flagged (block 305) as a potential P2P user.

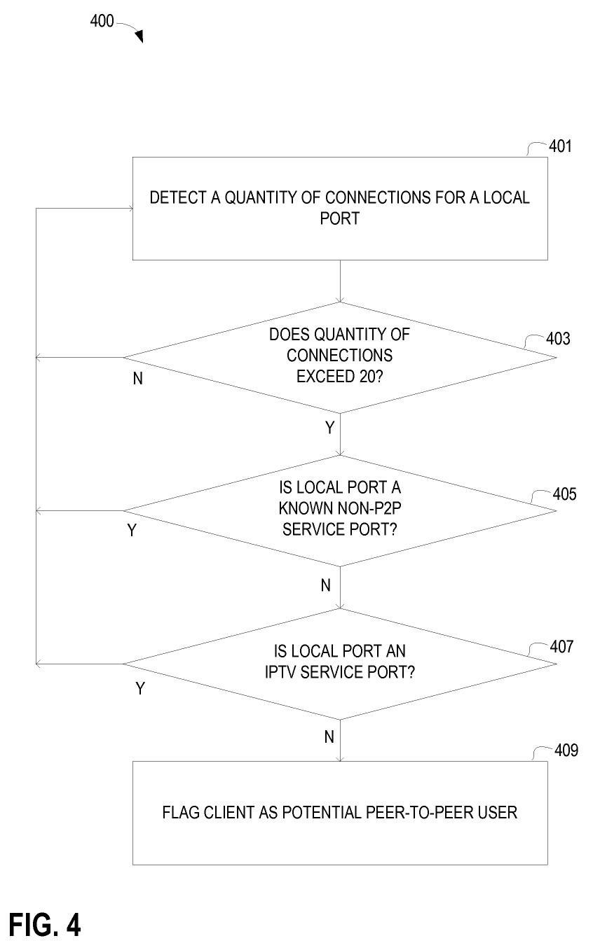

FIG. 4 depicts a further disclosed method 400 for potentially flagging a client as a P2P operator. As shown, a quantity of connections (e.g., communication sessions) for a local port is detected (block 401). If the quantity meets or exceeds a threshold value (e.g., 20) in block 403, then a determination is made (block 405) whether a local port is a known non-P2P service port. If yes (i.e., the local port is a known non-P2P service port), method 400 returns to detect (block 401) and analyze further potential P2P connections on other local ports. If the local port is not a known non-P2P operator, a determination is made (block 407) whether the local port is an IPTV service port. If yes (i.e., the local port is an IPTV service port), the method returns to detect (block 401) and analyze further connections to other local ports. As shown, if the quantity of connections exceeds (block 403) the threshold value and the local port is not a known non-P2P service port or IPTV service port, then method 400 includes flagging (block 409) the client as potentially running a P2P application (i.e., the client is flagged as a potential P2P user or operator).

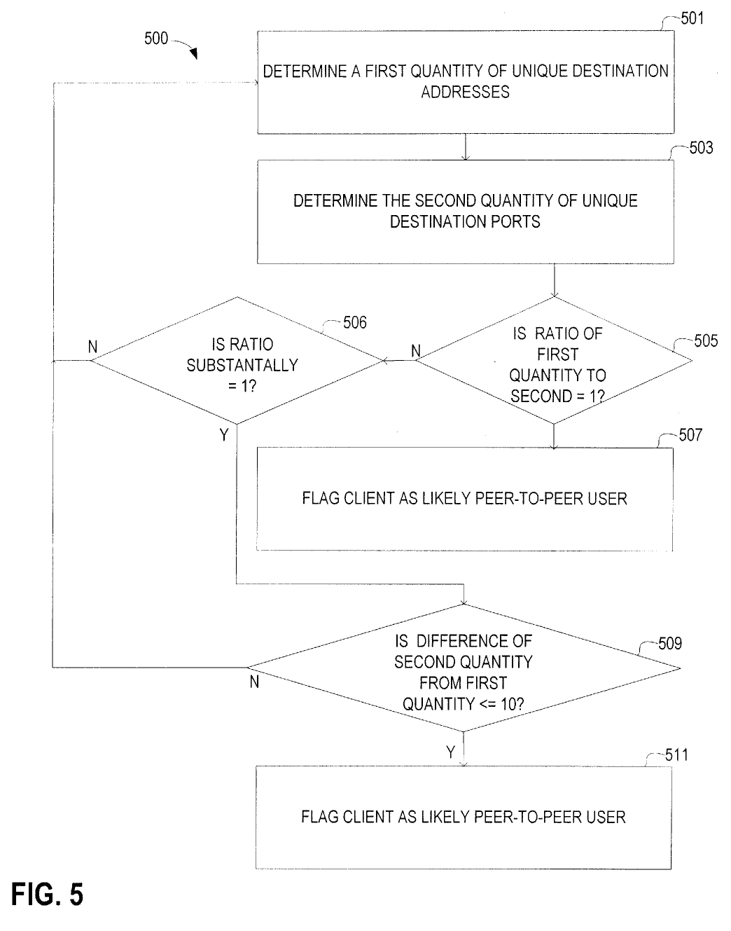

FIG. 5 depicts method 500 for detecting P2P connections. P2P detection server 110 (FIG. 1) or RG 104 (FIG. 1) may perform method 500. As shown in FIG. 5, method 500 includes analyzing (block 501) a NAT table to determine a first quantity of unique destination addresses and to determine (block 503) a second quantity of unique destination ports. A ratio is calculated of the first quantity to the second quantity, and if the ratio is equal to 1 (block 505), the client is flagged (block 507) as a potential P2P operator. If the ratio is substantially equal to 1 (block 506), a determination is made (block 509) whether the absolute value of the second quantity subtracted from the first quantity is less than or equal to a maximum threshold value of 10. As shown, if the difference is less than or is equal to 10, the client is flagged as a likely P2P operator (block 511). If the difference is greater than 10, a P2P application is not reported and the method is repeated as shown.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A process for detecting peer-to-peer connections from a local network address, the process comprising:
accessing a network address table to determine a quantity of available communication sessions;
storing the quantity of available communication sessions;
comparing the quantity of available communication sessions to a minimum level of communication sessions; and
storing a peer-to-peer connection variable as TRUE if the quantity of available communication sessions is equal to or less than the minimum level of communication sessions.

2. The process of claim 1, further comprising:
storing the peer-to-peer connection variable as FALSE if the quantity of available communication sessions is greater than the minimum level of communication sessions.

3. The process of claim 1, further comprising:
determining whether used communication sessions correspond to service ports; and
if a used communication session corresponds to a service port, subtracting a number of used communications sessions.

4. The process of claim 3, wherein the service ports include an Internet protocol television service port.

5. The process of claim 1, wherein the network address table is accessed from a residential gateway.

6. The process of claim 1, wherein the network address table includes 1024 entries.

7. The process of claim 1, wherein said accessing the network address table is further to determine:
a quantity of unique destination network addresses communicatively coupled to a local port; and wherein the process further comprising:
storing the quantity of unique destination network addresses;
comparing the quantity of unique destination addresses to a maximum level of unique destination addresses; and
storing the peer-to-peer connection variable as TRUE if the quantity of unique destination addresses meets or exceeds the maximum level of unique destination addresses.

8. The process of claim 7, further comprising:
storing the peer-to-peer connection variable as FALSE if the quantity of unique destination addresses is less than the maximum level of unique destination addresses.

9. The process of claim 7, further comprising:
comparing an identifier of the local port to a plurality of service port identifiers; and
storing the peer-to-peer connection variable as FALSE if the quantity of unique destination addresses meets or exceeds the maximum level of unique destination addresses and the identifier of the local port corresponds to one or more of the plurality of service port identifiers.

10. The process of claim 7, further comprising:
repeating accessing the network address table to determine a quantity of unique destination network addresses for other local ports;
for individual ports of the local ports, comparing the quantity of unique destination addresses to a quantity of unique destination ports; and
storing the peer-to-peer connection variable as TRUE if the quantity of unique destination addresses is substantially equal to the quantity of unique destination ports.

11. The process of claim 7, further comprising:
repeating accessing the network address table to determine a quantity of unique destination network addresses for other local ports;
for individual ports of the local ports, determining a ratio of the quantity of unique destination addresses to a quantity of unique destination ports;
for individual ports of the local ports, determining a difference value by subtracting a quantity of unique destination ports from the quantity of unique destination addresses; and
storing the peer-to-peer connection variable as TRUE if the ratio is substantially 1 and the difference value is less than or equal to a maximum difference value.

12. The process of claim 11, wherein the maximum difference value is substantially 10.

13. The process of claim 11, further comprising:
storing the peer-to-peer connection variable as FALSE if the ratio is not substantially equal to 1 or is equal to 1.

14. The process of claim 11, further comprising:
storing the peer-to-peer connection as FALSE if the ratio is not substantially equal to 1 or is equal to 1 and the difference value is greater than the maximum difference value.

15. The process of claim 14, wherein the maximum difference value is 10.

16. The process of claim 7, wherein said accessing the network address table is performed by a residential gateway that stores the network address table.

17. The process of claim 16, further comprising:
transporting network address table data to a server.

18. The process of claim 16, wherein transporting network address table data to the server is responsive to a server request.

19. A detection server enabled for executing machine readable instructions stored on at least one tangible readable medium to detect peer-to-peer connections, the instructions including instructions for:
accessing a network address translation table of a client, wherein the network address translation table includes a plurality of entries indicating communication sessions between a local customer premises equipment device and at least one remote device, wherein individual entries of the plurality of entries are associated with a destination address, a destination port, a source port, and a source address;
determining whether a threshold number (N) of entries have differing source addresses while having the same destination address and same source port; and
responsive to determining that a threshold number (N) of entries have differing destination addresses, flagging the client as a potential peer-to-peer operator.

20. The detection server of claim 19, wherein the network address translation table is accessed from a residential gateway.

21. The detection server of claim 19, the instructions further comprising instructions for:
determining whether a difference value is less than or equal to a threshold number (X), wherein the difference value is an absolute value of:
a quantity of unique destination ports subtracted from a quantity of unique destination addresses; and
responsive to determining that the difference value is less than or equal to the threshold number (X), flagging the client as a potential peer-to-peer operator.

22. The detection server of claim 19, the instructions further comprising instructions for:
determining whether a difference value is less than or equal to a threshold number (X), wherein the difference value is an absolute value of:
a quantity of unique destination ports subtracted from a quantity of unique destination addresses; and
responsive to determining that the difference value is greater than the threshold number (X), unflagging the client as a potential peer-to-peer operator.

23. A residential gateway enabled for detecting that a local client is operating a peer-to-peer connection, the residential gateway comprising:
an interface for enabling communication over a network between the local client and the multiple remote sources;
a network address translation table stored on a tangible readable medium;
wherein then network address translation table includes session entries;
wherein the session entries include data indicating communication sessions between the local client and multiple remote sources, wherein each of the multiple remote sources being associated with a remote network address and a remote port; and
a processor enabled for determining:
a relationship between:
the remote network addresses associated with the multiple remote sources; and
the remote ports associated with the multiple remote sources.

24. The residential gateway of claim 23, wherein the relationship is a ratio.

25. The residential gateway of claim 24, wherein the processor is further enabled for reporting an existence of a peer-to-peer connection in response to the ratio being substantially equal to 1.

26. The residential gateway of claim 23, wherein the processor is further enabled for reporting the existence of the peer-to-peer connection to a detection server.
